(19) United States
(12) Patent Application Publication
(10) Pub. No.: US 2002/0191606 A1
(43) Pub. Date: Dec. 19, 2002

(54) Network system-wide error handling utilizing control bit modification

(75) Inventors: Shaofeng Wu, Sunnyvale, CA (US); Jerry Kuo, San Jose, CA (US); Po-Shen Lai, San Jose, CA (US); Jian Jin, San Jose, CA (US); Autumn Niu, San Jose, CA (US)

Correspondence Address: ARTER & HADDEN, LLP, 1100 HUNTINGTON BUILDING, 925 EUCLID AVENUE, CLEVELAND, OH, 44115-1475, US

(73) Assignee: Zarlink Semiconductor V.N. Inc., Irvine, CA

(21) Appl. No.: 10/142,022

(22) Filed: May 9, 2002

Related U.S. Application Data
(60) Provisional application No. 60/290,080, filed on May 10, 2001.

(51) Int. Cl. H04L 12/28

(52) U.S. Cl. 370/389

(57) ABSTRACT

A communication interface for processing errors between network devices. The communication interface includes an output interface of a first network device for generating output control information and parity information of output information transmitted therefrom, and an error-handling interface of a second network device, which error-handling interface is in operative communication with the output interface to process the output control information and the parity information of the output information by, checking parity of the parity information of the output information received from the first network device, terminating the output information when an error in the parity is detected, and recovering a boundary of the output information when an error in the output control information is detected.

### BACKGROUND OF THE INVENTION

This application claims priority under 35 U.S.C. 119(e) from U.S. Provisional patent application Serial No. 60/290,080 entitled “Network System-Wide Error Handling Utilizing Control-Bit Modification” and filed May 10, 2001.

### TECHNICAL FIELD OF THE INVENTION

This invention is related to network switches, and more specifically, methods for handling error detection and correction in such network devices.

### BACKGROUND OF THE ART

A local area network (LAN) exhibits some inherent error rate; that is, some fraction of the frames sent on that LAN will be corrupted by errors induced into the physical channel. A catenet (or bridged LAN), which is a collection of interconnected networks (typically LANs), will always have a higher error rate than any individual LAN in the set, since a frame traversing multiple LANs has multiple opportunities for corruption by induced errors. One more complex error detection and correction technique is forward error correction. Forward error correction algorithms are able to detect and correct certain classes of errors, however, the tradeoff is complexity of the algorithm and reduced channel capacity since the information may need to be sent redundantly. Since no popular LAN technology uses forward error correction techniques, any error induced by the physical channel should result in a frame being discarded. In fact, a single bit error introduced on any link in the catenet will cause that frame to be discarded by the next receiver. A more common form of check sequence is CRC (Cyclic Redundancy Check) which is able to detect (but not correct) virtually all channel-induced errors. Forward error correction algorithms are able to detect and correct certain classes of errors, however, the tradeoff is complexity of the algorithm and reduced channel capacity since the information may need to be sent redundantly.

Errors may also be introduced by the switches and switching fabric itself. These errors may be caused by memory errors and internal bus errors caused by the process of receiving, storing, and enqueuing frames for transmission, or possibly software problems within the switch. Realistically speaking, bit errors will occur occasionally, in a system comprising the switching fabric and one or more network switches at a rate of 10⁻¹³. In order to detect and correct such a low-level bit-error rate, a system-wide error handling architecture is needed. In general, the desired architecture must provide the following two main results: detection of as many erred messages as possible, and recovery from the bit errors.

### SUMMARY OF THE INVENTION

The present invention disclosed and claimed herein, in one aspect thereof, comprises a communication interface for processing errors between network devices. The communication interface includes an output interface of a first network device for generating output control information and parity information of output information transmitted therefrom, and an error-handling interface of a second network device, which error-handling interface is in operative communication with the output interface to process the output control information and the parity information of the output information by, checking parity of the parity information of the output information received from the first network device, terminating the output information when an error in the parity is detected, and recovering a boundary of the output information when an error in the output control information is detected.

### BRIEF DESCRIPTION OF THE DRAWINGS

For a more complete understanding of the present invention and the advantages thereof, reference is now made to the following description taken in conjunction with the accompanying Drawings in which:

FIG. 1 illustrates a system-level data flow diagram in accordance with a novel embodiment;

FIG. 2 illustrates the position of the input error-handling block of the input data paths for the switching fabric;

FIG. 3 illustrates the position of the input error-handling block in the input data paths for the distributed switch;

FIG. 4 illustrates a block diagram of the input error-handling block;

FIG. 5 illustrates more detailed diagram of a data path for the input error-handling block;

FIG. 6 illustrates a state diagram for operations of the internal interface block;

FIG. 7 illustrates a memory data structure for the synchronization buffer and other associated queues; and

FIG. 8 illustrates a state diagram for operations of the synchronization buffer write control block.

### DETAILED DESCRIPTION OF THE INVENTION

The disclosed novel architecture provides a system-wide error-handling scheme that addresses bit error rates on the order of 10⁻¹³. The specific error-handling scheme involves including a parity bit in the interface to provide parity protection for the thirty-two data bits and two control code bits (OC/IC), which control code bits are output control (OC) bits when passed from a network device, and input control (IC) bits when received by a network device. The parity bit is generated at every output interface, and a parity check is performed at every input interface. (The parity bit is “0” when there is even parity on the thirty-two data bits and the two control code bits.) In this way, messages are always transmitted on the interface with good parity. (A device will never reverse the parity bit before transmitting a message on the interface.) Additionally, an input error-handling block is provided at all input ports. In general, this block detects parity errors, terminates messages when parity errors are detected, recovers message boundaries that have been altered due to bit errors in the two control bits, provides the coupling between the 32-bit input data bus and the 64-bit internal data buses, and synchronizes the input data to a system clock. There is also involved in the error handling scheme the use of End-of-Message (EOM) tag bits in all of the switching fabric queues as well as the distributed switch (DS) transmit-and-receive FIFO's. The EOM tag bits allow message boundaries to be detected in the queues and FIFO's. In this way, a device can recover when messages are shorter or longer than expected, due to bit errors.

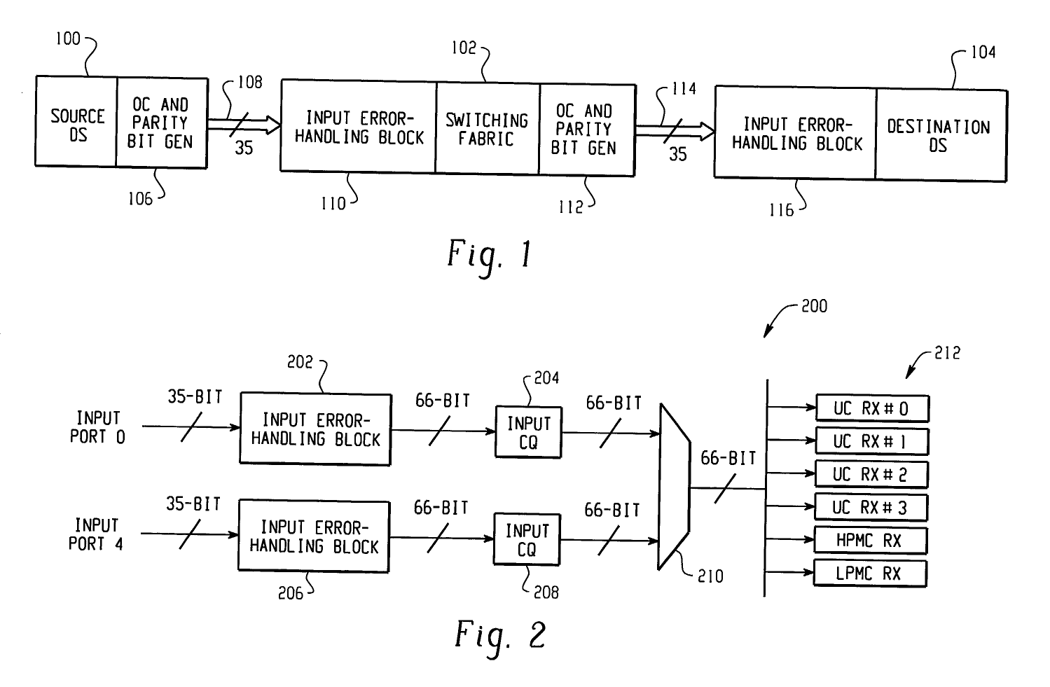

Referring now to FIG. 1, there is illustrated a system-level data flow diagram in accordance with a novel embodiment. A source DS 100 connects to a switching fabric 102 for the communication of information therethrough to a connected destination DS 104. The source DS 100 includes a source output block 106 (i.e., an output interface) for generation of OC bits and a parity bit. Information is communicated from the source output block 106 of the source DS 100 across a first data path 108 to a fabric input error-handling block 110 of the switching fabric 102. Thus the combination of the source output block 106 and the fabric input error-handling block 110 comprise a communication interface implemented between the network devices (DS 100 and switching fabric 102).

The first data path 108 accommodates 35-bit packet traffic that comprise the thirty-two data bits, two control code bits, and one parity bit. The switching fabric 102 includes the fabric input error-handling block 110 at each port for error handling, which error handling includes detecting parity errors, terminating messages when parity errors are detected, recovering message boundaries that have been altered due to bit errors in the two OC/IC control bits, providing coupling between a 32-bit input data bus of the first data path 108 and larger internal switch fabric or distributed switch buses (e.g., a 64-bit internal data bus), deleting the last 64-bit word in an erred message, and synchronizing the input data to a system clock. The only way that a destination frame engine of the destination DS 104 will know that a message was subject to bit error(s) on one or more of the interfaces is to change the message size.

The switching fabric 102 has a fabric output block 112 (similar to source output block 106) that performs generation of the OC bits and the parity bit. Thus after processing data packets within the switching fabric 102, each output port of the switching fabric 102 includes the fabric output block 112 for OC and parity bit generation for each data packet passing through the respective port. The data packets are then communicated over a second data path 114 to the destination DS 104. The destination DS 104 also includes a DS input error-handling block 116 for error handling in accordance with that which is described with the fabric input error-handling block 110.

As indicated hereinabove, input error handling is provided at all input ports. In other words, for the DS 104 having a single input port, that input port has an input error-handling block 116 associated therewith. Where the switching fabric 102 has eight input ports, each of the eight input ports has an input error-handling block 110 associated therewith.

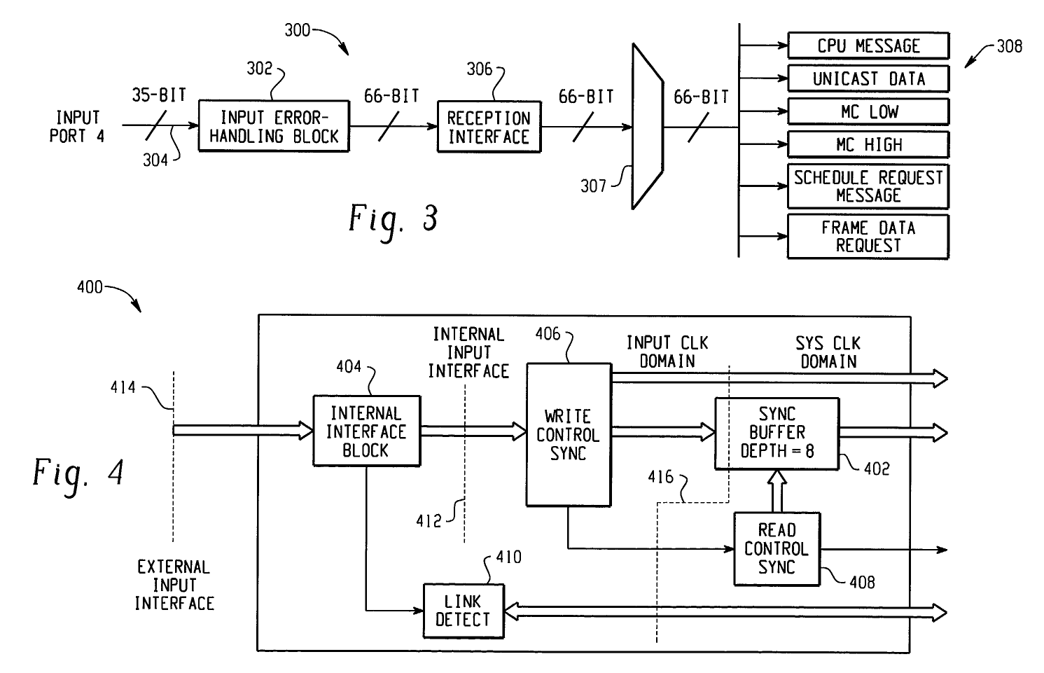

Referring now to FIG. 2, there is illustrated the location of the input error handling block 202 (similar to fabric error-handling block 110) for an input port of a switching fabric input module 200. Only one of the four input modules is presented, when continuing with the example 8-port switching fabric device 102 from above. In the switching fabric device 102, each input port includes the input error-handling block interstitial to the input interface and an input coupling queue 204. That is, a first port (denoted Input Port 0) has the corresponding fabric input error-handling block 202 positioned before its input coupling queue 204. A second port (denoted Input Port 4) has a corresponding fabric input error-handling block 206 positioned before its input coupling queue 208. As indicated hereinabove, one function of the error-handling block is to interface the 32-bit data input bus to internal 64-bit bus of the switching fabric device 102. Thus the output of the fabric error handling block 202 is a 66-bit word that includes a 64-bit data word and two tag bits.

The 66-bit outputs of both of the input coupling queues (204 and 208) connect to a fabric multiplexer 210 that switches between its inputs to selectively determine which of the packets enqueued in the input coupling queues (204 and 208) will be passed through to internal buffers 212. In this particular embodiment, the internal buffers 212 include four unicast receive buffers (denoted UC RX #0-3), a low-priority multicast buffer (denoted LPMC RX), and a high-priority multicast buffer (denoted HPMC RX).

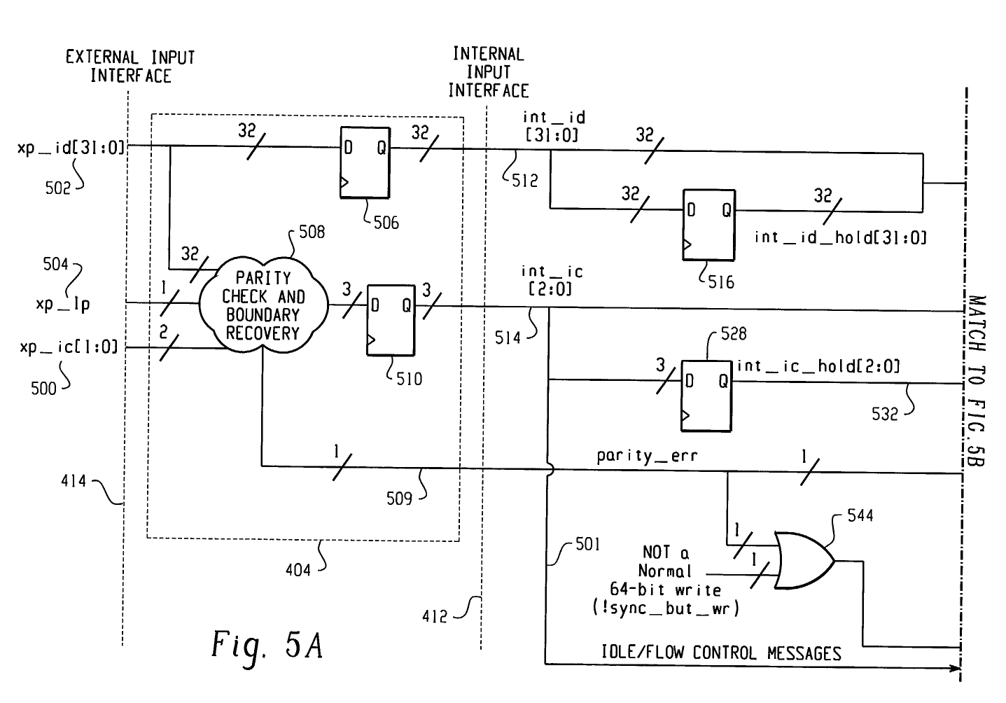

Referring now to FIG. 3, there is illustrated the location of a DS input error handling block 302 (similar to DS input error-handling block 116) for a single input port 300 in the destination DS 104. For the destination DS 104, its DS input error-handling block 302 sits interstitial to an input port interface 304 and, a reception interface 306 and receive FIFOs 308. The input port interface 304 receives 35-bit packets which are passed into the DS input error-handling block 302, processed, and passed therefrom as 66-bit packets to the reception interface 306. Output of the reception interface 306 is a 66-bit path to a DS multiplexer 307 that passes its the 66-bit packets at its input to the receive FIFOs 308, which FIFOs 308 separately accommodate the following: a CPU message, unicast data, multicast high and low priority data (MC HI and MC LO), schedule request messages, and frame data requests.

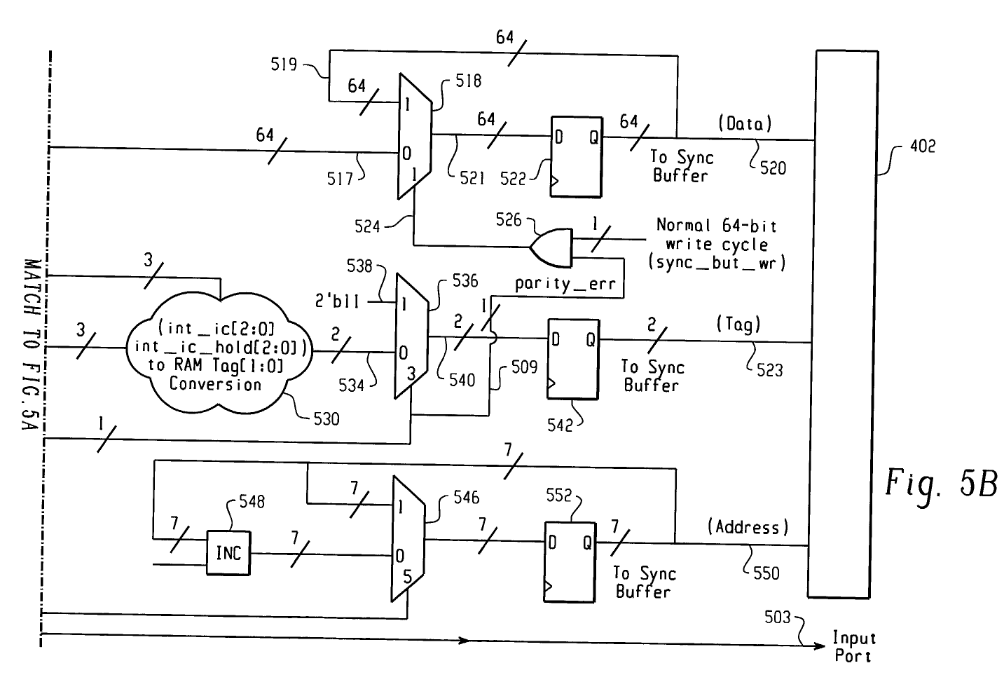

Referring now to FIG. 4, there is illustrated a block diagram of an input error-handling block 400. The input error-handling block 400 consists of a synchronization (“sync”) buffer 402 and four sub-blocks; an internal interface unit 404 (int_xp); a synchronization buffer write control block 406 (sync_wr_ctl); a synchronization buffer read control block 408 (sync_rd_ctl); and a link detect block 410 (link_detect). Note that the synchronization buffer 402 is very shallow, i.e., it has a depth of eight. Additionally, an internal input interface 412 exists between the internal interface unit 404 and the synchronization buffer write control block 406. Each external input interface 414 consists of thirty-five bits: thirty-two bits of external input data; two bits of external IC code; and one bit for external input parity. The external IC bits are defined in the following Table 1.

TABLE 1
IC Bit Definitions
External IC Codes

| xp_ic[1:0] | Description |
|---|---|
| 10 | Start of Message (SOM) |
| 00 | Middle of Message (MOM) |
| 01 | End of Message (EOM) |
| 11 | Idle/Flow Control Message (IDLE) |

Idle/Flow Control messages do not follow the same path (i.e., not pass through the synchronization buffer data path) as the rest of the messages, but are re-directed at the internal input interface 412 and passed on to the input port as quickly as possible. This is required, since Idle/Flow Control messages must be handled immediately upon receipt.

For each input port, the synchronization buffer 402 overlaps a clock domain interface 416 (represented by the dotted line) that provides demarcation between the input clock domain and the system clock domain. As illustrated, the synchronization buffer 402 is a dual-port SRAM (static random-access memory). The write-side of the SRAM is in the input clock domain and the read-side of the SRAM is in the System Clock domain.

As illustrated in the input error-handling block 400, the synchronization buffer write control block 406 lies between the internal input interface 412 and the synchronization buffer 402. The main output of the synchronization buffer write control block 406 is to write the input data into the 66-bit wide synchronization buffer 402. As mentioned hereinabove, the synchronization buffer write control block 406 is responsible for performing the following functions: providing the two tag bits for the synchronization buffer 402 and queues; providing the coupling between the 32-bit input data bus and the 64-bit internal data buses; deleting the last (or only) 64-bit word of an erred message; writes the input data into the 66-bit wide synchronization buffer 402; and re-directing Idle/Flow Control Messages at the internal input interface 412 to the input port as quickly as possible.

The synchronization buffer read control block 408 interfaces with the synchronization buffer 402 and the synchronization buffer write control block 406. For every system clock tick, if the synchronization buffer 402 is not empty, the synchronization buffer read control block 408 is responsible for reading the input data from the 66-bit wide synchronization buffer 402. In other words, the synchronization buffer read control block 408 will continuously read data from the synchronization buffer 402 as long as the synchronization buffer 408 is not empty. Note that the synchronization buffer read control block 408 operates in the system clock domain.

The main function of the link detect block 410 is to continuously detect and determine the state of the link.

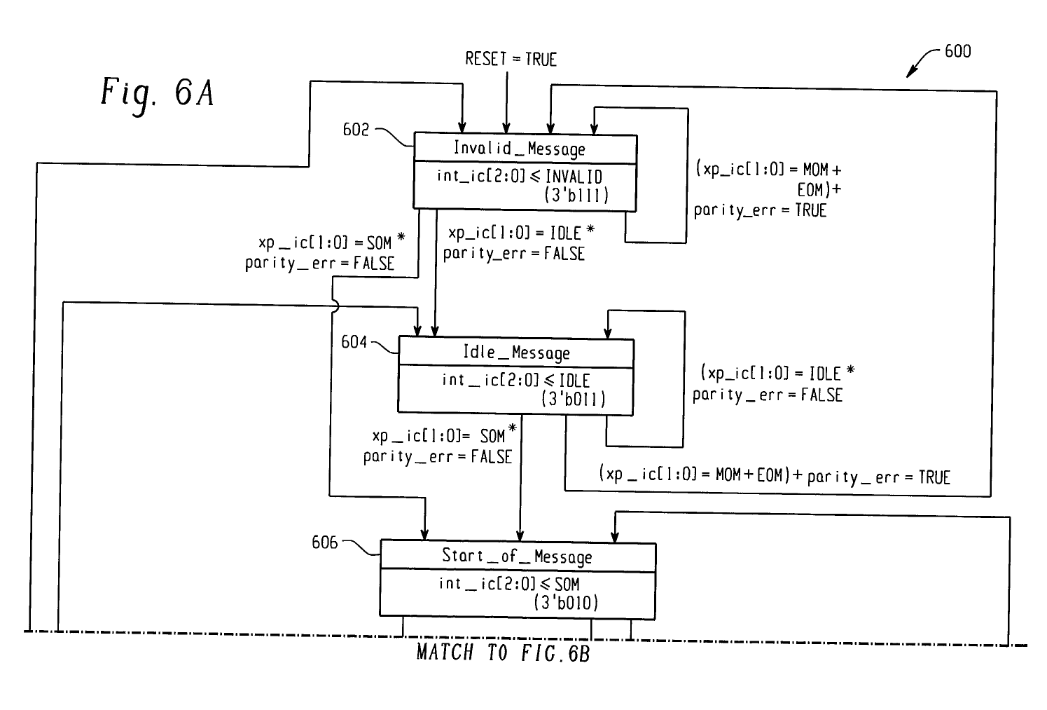

Referring now to FIG. 5, there is illustrated the data path from the external input interface 414 to the synchronization buffer 402 of the input error-handling block 400 of FIG. 4. Note that idle/flow control messages provided as part of the two input control bits (xp_ic[1:0]), at an external control bit input 500, do not follow the same path as the rest of the messages. The idle/flow control messages are re-directed along a path 501 at the internal input interface 412 and passed on as quickly as possible to a flow control input port 503, and thus do not pass through the synchronization buffer 402. As mentioned hereinabove with respect to the SF 102, the synchronization buffer 402 is located in front of the input coupling queue (e.g., input coupling queue 204), and for the DS 104 the synchronization buffer 402 is located in front of the receive FIFOs (e.g., receive FIFOs 308).

As shown in FIG. 4 (and FIG. 5), the internal interface block 404 lies interstitial to the external input interface 414 and the internal input interface 412. The internal interface block 404 is responsible for performing the following functions: providing a clean internal input interface for an input port; detecting parity errors on the external input interface 414; terminating a message when a parity error is detected on the external input interface 414; and recovering message boundaries that have been altered due to undetected bit errors in the external input control bits 500.

The internal interface block 404 receives at the external input interface 414 thirty-two external input data bits (denoted xp_id[31:0]) at an external data input 502, a single external input parity bit (denoted as xp_ip) at an external parity input 504, and the two external input control bits (denoted xp_ic[1:0]) at an external IC bit input 500. The external input data bits at-the external data input 502 are passed in parallel to a first internal interface logic 506 and a parity check and boundary recovery logic 508. The parity check and boundary recovery logic 508 receives as additional inputs the single external input parity bit from the external parity input 504 and the two external input control bits at the external IC bit input 500. The output of the parity check and boundary recovery logic 508 is a 3-bit word passed to a second internal interface logic 510, and a single internal parity bit (parity_err) forwarded on an internal parity line 509. The single internal parity bit is determined as the result of a parity check performed on the thirty-two external input data bits and external IC bits that are input to the parity check and recovery logic 508).

Part of the job of the internal interface block 404 is to provide a “clean” input interface for its associated input port (e.g., input port 0 of FIG. 2, or input port 4 of FIG. 3), referred to as the internal input interface 412. The internal input interface 412 requires an extra IC bit (i.e., from a total of thirty-five bits at the external interface 414 to thirty-six bits at the internal input interface 412, generated at the parity check and boundary recovery logic 508, and clocked through an output 514 of the second internal interface logic 510) in order to communicate some additional and necessary information to the input port of the synchronization buffer 402, which input port comprises a data output 520 that carries the 64-bit data, a tag port 523 that carries the 2-bit tag information, and the flow control port 503 that carries the idle/flow control messages. Additionally, as indicated hereinabove, the external input parity bit from the external parity input 504 is not passed to the internal input interface 412.

Continuing on with the data path description of FIG. 5, the output of the first internal interface logic 506 is a 32-bit internal data word (denoted int_id[31:0]) that flows in parallel on a path 512 to both a first sync logic 516 and a first dual-input multiplexer 518 (or “mux”). The output of the first sync logic 516 is a 32-bit internal data hold word (denoted int_id_hold[31:0]) that together with the 32-bit internal data word form an internal 64-bit data word at a first mux input 517 to the first multiplexer 518. The first multiplexer 518 has a second mux input 519 which receives a 64-bit output sync buffer word from the data output 520 that is also forwarded to the sync buffer 402. A mux output 521 of the first multiplexer 518 connects to a second sync logic 522 and carries a 64-bit mux word (either the 64-bit output sync buffer word or the internal 64-bit data word) that is clocked through the second sync logic 522 to the data output 520.

The first multiplexer 518 has a parity input 524 that receives a signal to control which of the data at the first mux input 517 or second mux input 519 is clocked through the first mux 518 to the second sync logic 522. Control thereto is from an AND gate 526 that has as a first input a normal 64-bit sync buffer write cycle signal (denoted sync_buf_wr), and the parity_err signal on the internal parity path 509 from the parity check and boundary recovery logic 508.

At the output 514 of the second internal interface logic 510 a 3-bit internal IC word (denoted int_ic[2:0]) is passed in parallel to a third sync logic 528 and a converter 530. As indicated hereinabove, only the idle/flow control messages of the int_ic[2:0] word are passed along the path 501 directly to the input port 503. The other messages configurable by the internal IC codes are clocked through the third sync logic 528 to output a 3-bit internal IC hold word (denoted int_ic_hold[2:0]) to the converter 530 from a third sync output 532 of the third sync logic 528.

The converter 530 converts the int_ic[2:0] word and the int_ic_hold[2:0] words to a 2-bit RAM tag[1:0] word. A converter output 534 of the converter 530 carries the 2-bit tag word to a first mux input of a second dual-input multiplexer 536. The second dual-input multiplexer 536 has the 2-bit binary value of 2′b11 as a second mux input 538. The output of the second multiplexer 536 is a 2-bit word that is either the value 2′b11 or the tag word. Selection of either of the two inputs (534 or 538) for output at a second mux output 540 of the second multiplexer 536 is by the same parity_err bit carried on the internal parity path 509. The second mux output 540 connects to a fourth sync logic 542 wherein the 2-bit tag is clocked therethrough on the tag port 523 to the synchronization buffer 402.

Address incrementing to the synchronization buffer 402 is provided from the internal parity path 509. A dual-input 1-bit OR gate 544 receives the parity_err signal at one input and a lsync_buf_wr signal (not a normal 64-bit write cycle signal) at a second input. The output is then passed as a control input to a third dual-input multiplexer 546. The third multiplexer 546 has as a first 7-bit mux input, the 7-bit output of a counter 548. The second mux input receives a 7-bit address from an address output 550, which address output 550 also connects to the synchronization buffer 402. The address output 550 also provides the 7-bit address to a second input of the counter 548. The output of the third multiplexer 546 provides the input to a fifth sync logic 552, the output of which is the address output 550 that connects to the synchronization buffer 402.

In summary, the internal input interface 412 consists of thirty-six bits: thirty-two bits of internal input data that are output from the first internal interface logic 506, three bits of internal IC code 514 (denoted int_ic[2:0]), and one parity bit (parity_err) on the parity line 509. The internal IC bits 514 are summarized in Table 2.

TABLE 2
Internal IC Code Definitions

| int_ic[2:0] | Description |
|---|---|
| 010 | Start of Message (SOM) |
| 000 | Middle of Message (MOM) |
| 001 | End of Message - NO error (EOM_OK) |
| 101 | End of Message - error (EOM_ERR) |
| 011 | Idle/Flow Control Message (IDLE) |
| 111 | Invalid Message (INVALID) |
| 100 | NOT USED |
| 110 | NOT USED |

In all cases, the internal interface block 404 passes the external input data xp_id[31:0] from the external input interface 414 to the internal input interface 412 without any modification. However, this is not the case for the external IC bits xp_ic[1:0]. For every input clock tick, the internal interface block 404 creates new internal IC bits int_ic[2:0] based upon the legal or illegal external IC bit transitions and parity detection. (Illegal external IC bit transitions are a result of bit errors, and may or may not be detected by the parity check logic 508.)

By comparing the encoding and descriptions of the external IC bits xp_ic[1:0] and internal IC bits int_ic[2:0], there are two main differences between the two versions of IC bits (external and internal), in addition to the obvious difference in the number of bits. For the internal IC bits int_ic[2:0 ], there is a distinction between an “End of Message-error” (EOM-ERR) and an “End of Message-NO error” (EOM-OK). Additionally, there is an encoding for an Invalid Message (INVALID).

The EOM_ERR indication is required when the internal interface block 404 detects a parity error and/or an illegal external IC bit transition while receiving a message. When this occurs, the internal interface block 404 terminates the message by encoding the internal IC bits int_ic[2:0] with the EOM_ERR indication. For the following clock ticks, the internal interface block 404 encodes the internal IC bits int_ic[2:0] with the INVALID indication, until the next idle/flow control message or Start_of_Message is detected.

The INVALID indication is required, when there are dead cycles on the internal input interface 412. This condition occurs when message termination and message boundary recovery are needed. For these two cases, all or part of a message may need to be discarded as it is being received on the external input interface 414. As a result, dead cycles are created at the internal input interface 412. For every dead cycle, it is the job of the internal interface block 404 to provide an INVALID indication on the internal IC bits int_ic[2:0]. The INVALID indication is not required for the external input interface 414. For every clock tick, a message is always being transmitted on the external input interface 414, even if a command or data message is not available for transmission. This is possible, because an idle/flow control message is always sent out on the external input interface 414 when there is nothing else to send.

For every input clock tick, a parity check is performed on the external input interface 414 signals via the parity check and boundary recovery logic 508. The parity check is done by generating the parity bit for the external input data and external input IC bits (i.e., xp_id+xp_ic[1:0]), and comparing the result to the external input parity bit (xp_ip). If the result is not the same, the parity_err signal on the parity line 509 is asserted. (Note that the parity bit is zero when there is even parity on xp_id+xp_ic[1:0]).

Termination of a message due to detection of a parity error creates one of the following three scenarios whereby the erred portions of the message and the error message are marked for discard, and discarded. Firstly, if a parity error is detected on the first thirty-two bits of the message, the entire message is discarded. Secondly, if a parity error is detected in the middle of the message, that portion of the message at the logical divide is immediately terminated with the End_of_Message_ERR indication on the internal IC bits int_ic[2:0]. In this way, the first part of the message is forwarded through the device, but the last part of the message that is erred and the error message, are discarded. This results in a shortened message. Lastly, if a parity error is detected on the last thirty-two bits of the message, the message is immediately marked with the End_of_Message_ERR indication on the internal IC bits int_ic[2:0]. However, in this case, the entire message is forwarded through the device. The message still retains its original size.

Message boundary recovery due to undetected bit errors in the external IC bits xp_ic[1:0] creates one of the following three scenarios: the message is shortened due to an erroneous sequence on the external IC bits xp_ic[1:0]; the message is concatenated with part or all of another message (or messages) due to an erroneous sequence on the external IC bits xp_ic[1:0]; or the message is dropped due to an erroneous sequence on the external IC bits xp_ic[1:0].

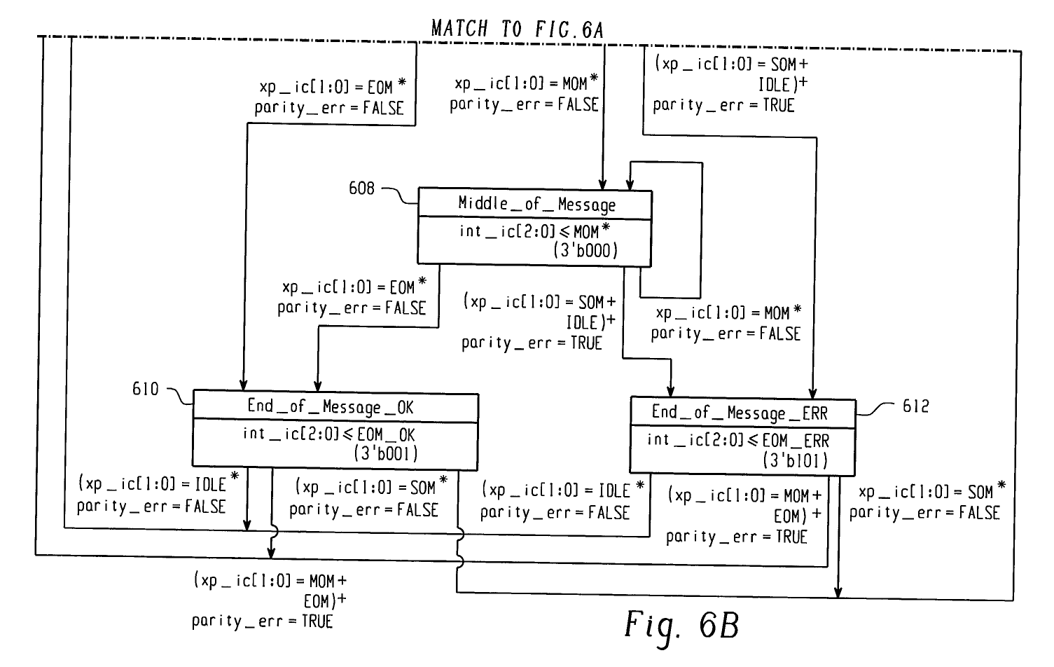

Referring now to FIG. 6, there is illustrated a state diagram 600 of the Internal IC Code Messaging (int_ic[2:0]). The state diagram 600 includes the following six code descriptions (or states): an Invalid_Message state 602; an Idle_Message state 604; a Start_of_Message state 606; a Middle_of_Message state 608; an End_of_Message_OK state 610; and an End_of_Message_ERR state 612.

The Invalid_Message state 602 occurs when the logic state int_ic[2:0]<=INVALID (with a binary value of 3′b111) occurs. The Invalid_Message state 602 has as one input, a reset=TRUE for initialization of the state into a known condition when that logic state occurs. The Invalid_Message state 602 also has a loop back signal wherein if the following logic state occurs, (xp_ic[1:0]=MOM+EOM)+parity_err=TRUE, then the output of the Invalid_Message state 602 loops back to its input. The Invalid_Message state 602 also has two additional inputs which will be discussed hereinbelow that loop back from the outputs of subsequent states, i.e., the Idle_Message state 604 and the End_of_Message_ERR state 612. Additionally, processing flows from the Invalid_Message state 602 to the Start_of_Message state 606 when the logic state xp_ic[1:0]=SOM * parity_err=FALSE occurs. Processing flows from the Invalid_Message state 602 to the Idle_Message state 604 when the logic state xp_ic[1:0]=IDLE * parity_err=FALSE occurs.

Flow is to the Idle_Message state 604 when the logic value of int_ic[2:0]<=IDLE (with a binary value of 3′b011) occurs. The Idle_Message state 604 also has a loop back state wherein if the following logic state occurs, xp_ic[1:0]=IDLE * parity_err=FALSE, then the output loops back to its input. An output of the Idle_Message state 604 also loops back to the input of the Invalid_Message state 602 when the logic state xp_ic[1:0]=MOM+(EOM)+parity_err=TRUE occurs. State flow continues to the Start_of_Message state 606 from the Idle_Message state 604 when the logic state of xp_ic[1:0]=SOM * parity_err=FALSE occurs.

Flow is to the Start_of_Message state 606 when the logic state int_ic[2:0]<=SOM (with a binary value of 3′b010) occurs. The Start_of_Message state 606 has one additional input then those mentioned hereinabove, and three outputs. The third input is from the output of the End_of_Message_OK state 610. A first output directs flow to the End_of_Message_OK state 610 when the logic state xp_ic[1:0]=EOM * parity_err=FALSE occurs. A second output from the Start_of_Message state 606 flows to the End_of_Message_ERR state 612 when the value (xp_ic[1:0]=SOM+IDLE)+parity_err=TRUE. The last output of the Start_of_Message state 606 occurs to the Middle_of_Message state 608 when the value of xp_ic[1:0]=MOM * parity_err=FALSE.

Flow is to the Middle_of_Message state 608 when tie logic state of int_ic[2:0]<=MOM (with a binary value of 3′b000) occurs. The Middle_of_Message state 608 as a loop back path that is taken when the logic state of xp_ic[1:0]=MOM * parity_err=FALSE occurs. That is, the loop back occurs from its output back to its input. The Middle_of_Message state 608 has a second output to the End_of_Message_OK state 610 when the logic state of xp_ic[1:0]=EOM * parity_err=FALSE occurs. Lastly, the remaining output of the Middle_of_Message state 608 flows to the End_of_Message_ERR state 612 when the logic state of (xp_ic[1:0]=SOM+IDLE)+parity_err=TRUE occurs.

Flow is to the End_of_Message_OK state 610 when a logic state of int_ic[2:0]<=EOM_OK (with a binary values of 3′b000) occurs. The End_of_Message_OK state 610 includes the two inputs described hereinabove, and three outputs. The first output loops back to the Idle_Message state 604 when the logic state of xp_ic[1:0]=IDLE * parity_err=FALSE occurs. The second output causes loop back to the input of the Invalid_Message state 602 when the logic state of (xp_ic[1:0]=MOM+EOM)+parity_err=TRUE occurs. The last output of the End_of_Message_OK state 610 flows back to the input of the Start_of_Message state 606 when the logic state of xp_ic[1:0]=SOM * parity_err=FALSE occurs.

Flow is to the last state, which is the End_of_Message_ERR state 612, when a logic state of int_ic[2:0]<=EOM_ERR (with abinary value of 3′b101) occurs. The End_of_Message_ERR state 612 has two inputs, which were described hereinabove, and three outputs. The first output causes flow back to the input of the Idle_Message state 604 when the logic state of xp_ic[1:0]=IDLE * parity_err=FALSE occurs. The second output causes flow back to the input of the Invalid_Message state 602 when the logic state of (xp_ic[1:0]=MOM+EOM)+parity_err=TRUE occurs. The last output causes flow back to the input of the Start_of_Message state 606 when the logic state of xp_ic[1:0]=SOM * parity_err=FALSE occurs.

As was indicated before, another important part of the error handling scheme is the “End of Message” (EOM) tag bits in all of switching fabric queues, as well as distributed switch transmit-and-receive FIFO's. These tag bits are necessary for recovering message boundaries inside the queues when the expected length of a packet is different from the actual length. This can happen for any type of message, such as a command message or a data message. The actual length can be different from the expected length for two main reasons. Firstly, the message (or a previous message) was subject to bit errors on one or more of the interfaces (internal 412 or external 414). As a result, message boundary recovery and/or message termination actions were required by the input error-handling block (e.g., 202, 206, 302, and 400) that affected the length of the message. Secondly, the payload field and/or the type field of the message has undetected bit errors. When there are bit errors in either the payload field and/or the type field, some very erroneous actions can take place. For example, when there are undetected bit errors in the type field, the DS input port 304 errantly cause insertion of a frame data request message (of the FIFO set of FIG. 3) into a UC data message FIFO, and vice versa. In this way, the Message Header information can not be counted on for recovery of message boundaries. The tag bits must be relied upon in the queues and FIFOs.

As mentioned hereinabove, the error-handling scheme involves the use of “End of Message” (EOM) tag bits in all of switching fabric queues, as well as DS transmit-and-receive FIFOs (this includes the synchronization buffer 402). The EOM tag bits allow message boundaries to be detected in the queues and FIFOs. In this way, a device can recover when messages are shorter or longer than expected due to bit errors on one or more of the interfaces (ie., internal 412 and external 414). The two tag bits are defined as follows in Table 3.

TABLE 3
Tag Bit Description

| Tag[65:64] | Description |
|---|---|
| 00 | Start of Message/Middle of Message (SOM/MOM) |
| 01 | End of Message with 32 bits valid (EOM_32) |
| 11 | End of Message with 64 bits valid (EOM_64) |
| | or |
| | 64-bit single-tick message |
| 10 | NOT USED |

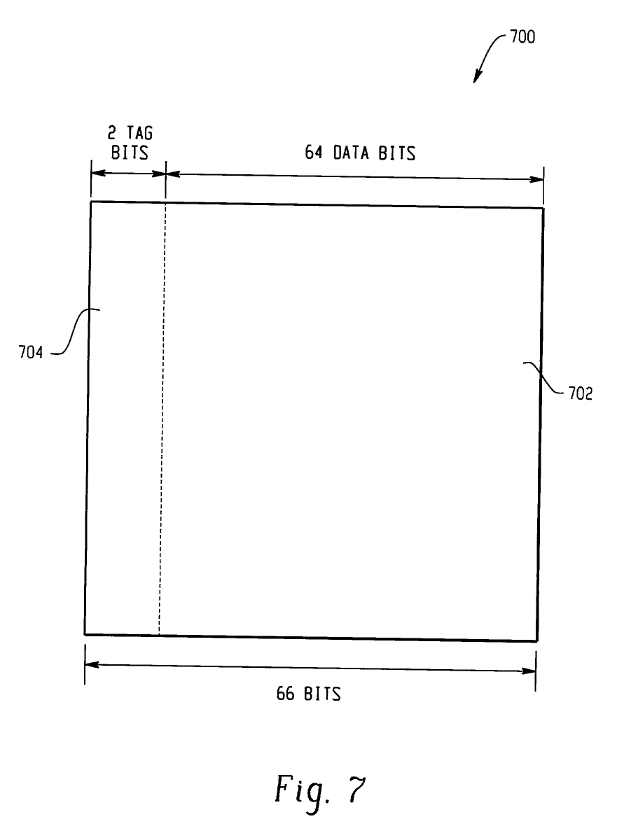

Referring now to FIG. 7, there is illustrated a diagram of the memory data structure 700 for the synchronization buffer 402 and the other queues. The memory data structure 700 is a total of sixty-six bits in length comprising data information 702 in sixty-four bits and tag information 704 in two bits. The internal data buses are sixty-six bits wide (i.e., sixty-four data bits and two tag bits). Thus, as mentioned hereinabove, one function of the write control synchronization block 406 is to provide the coupling between the 32-bit XPipe Input data bus and the 66-bit internal data buses.

In most cases, an input port has no way of discarding an entire message once it has been partially received. As a result, when parity errors and/or illegal external IC bit transitions are detected in the middle of receiving a message, it is not possible to discard the entire message. However, it is possible to at least discard the last 64-bit word of an erred message, and in many cases, it is possible to discard more of the message. In this way, whenever the write control synchronization block 406 receives the EOM_ERR indication on the internal input interface 412, it will not write the last 64-bit word (or only word) into the synchronization buffer 402. Instead, it will mark the second-to-last 64-bit word with the “End_of_Message_{—}64_bits_valid (EOM_64)” indication, for the following reason. The only way that the destination frame engine will know that a message was subject to bit error(s) of one or more of the interfaces (i.e., internal 412 and external 414) is to change the message size. The frame engine in the destination DS 104 will detect the difference in message size and will send an indication to the MAC (media access controller) to invert the CRC (cyclic redundancy check).

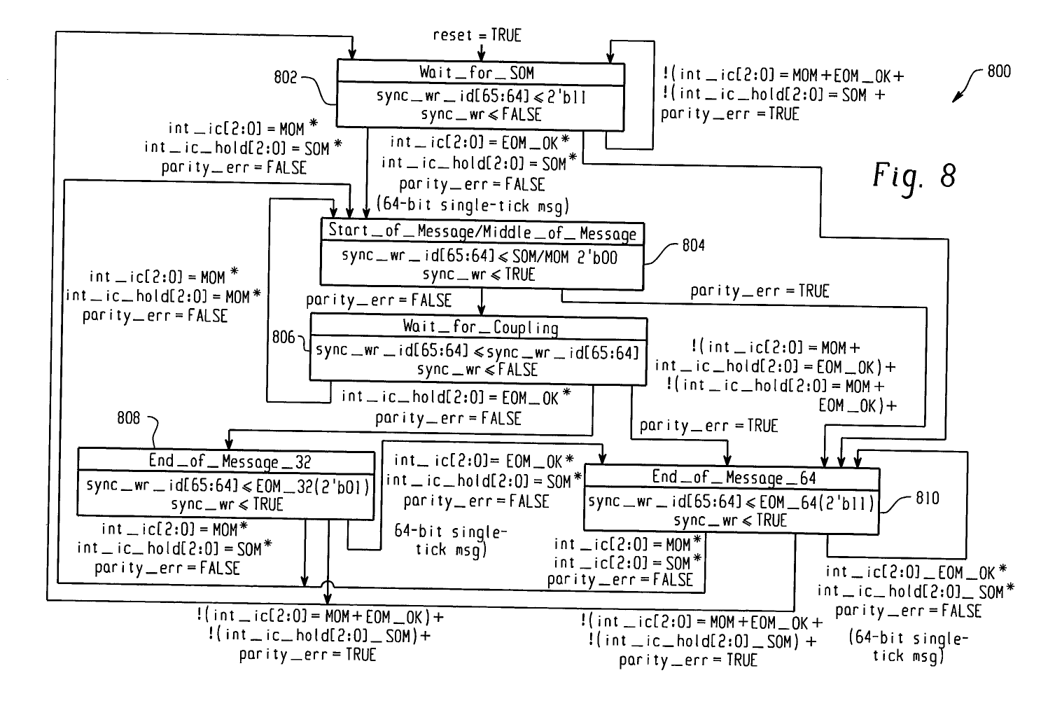

Referring now to FIG. 8, there is illustrated a state diagram 800 for the write control synchronization block 406 of FIG. 4. The write control state diagram 800 includes the following five states: a Wait_for_SOM state 802; a Start_of_Message/Middle_of_Message state 804; a Wait_for_Coupling state 806; an End_of_Message_32 state 808; and, an End_of_Message_64 state 810.

Flow is to the Wait_for_SOM state 802 when both the conditions sync_wr_id[65:64]<=2′b11 and sync_wr<=FALSE occur. The Wait_for_SOM state 802 has three inputs. A first input is for a logic state of reset=TRUE for initializing the state diagram into a known condition. Additionally the Wait_for_SOM state 802 has a loop back condition wherein its output loops back to its input when the logic state of !(int_ic[2:0]=MOM+EOM_OK)+!(int_ic_hold[2:0]=SOM)+parity_err=TRUE occurs. The remaining input is a loop back from the output of the End_of_Message_64 state 810, and will be discussed therewith hereinbelow. The Wait_for_SOM state 802 has two outputs. A first output flows to the Start_of_Message state 804 when the logic state of int_ic[2:0]=MOM * int_ic_hold[2:0]=SOM * parity_err=FALSE occurs. The second output causes flow to the End_of_Message_64 state 810 when the logic state of int_ic[2:0]=EOM_OK * int_ic hold[2:0]=SOM * parity_err=FALSE occurs. Note that this second output occurs as a 64-bit single-tick message.

Flow is to the Start_of_Message/Middle_of_Message state 804 when the conditions sync_wr_id[65:64]<=SOM/MOM (with a binary values of 2′b00), and sync_wr<=TRUE. The Start_of_Message/Middle_of_Message state 804 includes three inputs, one of which was discussed with respect to the Wait_for_SOM state 802. A second input is received from an output of the End_of_Message_64 state 810, and a third input is received from the Wait_for_Coupling state 806, both of which will be discussed with respect to those states. The Start_of_Message/Middle_of_Message state 804 has two outputs. The first output accommodates flow to the Wait_for_Coupling state 806 when the value of parity_err=FALSE. The second output causes flow to the End_of_Message_64 state 810 when the logic state of parity_err=TRUE.

The Wait_for_Coupling state 806 has one input, as described hereinabove, and three outputs. The first output follows a loop back to the input of the Start_of_Message/Middle_of_Message state 804 when the logic state of int_ic[2:0]=MOM * int_ic_hold[2:0]=MOM * parity_err=FALSE occurs. The second output flows to the End_of_Message_32 state 808 when the logic state of int_ic_hold[2:0]=EOM_OK * parity_err=FALSE occurs. The last output flows to the End_of_Message_64 state 810 when the logic state of !(int_ic[2:0]=MOM+int_ic_hold[2:0]=EOM_OK)+!(int_ic_hold[2:0]=MOM+EOM_OK)+parity_err=TRUE occurs.

Flow progresses in the state diagram to the End_of_Message_32 state 808 when both the logic conditions of sync_wr_id[65:64]<=EOM_32 (with the binary values of 2′b01) and sync_wr<=TRUE occur. The End_of_Message_32 state 808 has one input, as described hereinabove with respect to the Wait_for_Coupling state 806, and three outputs. A first output flows back to the input of the Start_of_Message/Middle_of_Message state 804 when the logic state of int_ic[2:0]=MOM * int_ic_hold[2:0]=SOM * parity_err =FALSE occurs. A second output flows back to the input of the Wait_for_SOM state 802 when the logic state of !(int_ic[2:0]=MOM+EOM_OK)+!(int_ic_hold[2:0]=SOM)+parity_err=TRUE occurs. The last output flows to the input of the End_of_Message_64 state 810 when the logic state of int_ic[2:0]=EOM_OK * int_ic hold[2:0]=SOM * parity_err=FALSE occurs. Note that this is a 64-bit single-tick message.

Flow in the state diagram passes to the End_of_Message_64 state 810 when both the logic conditions value of sync_wr_id[65:64]<=EOM_64 (with a binary value of 2′b11) and sync_wr<=TRUE occur. The End_of_Message_64 state 810 has five inputs, four of which were discussed hereinabove with respect to the various connecting states. The fifth input is a loop back path from the output of the End_of_Message_64 state 810 when the value of int_ic[2:0]=EOM_OK * int_ic_hold[2:0]=SOM * parity_err=FALSE occurs. Note that this is a 64-bit single-tick message. The End_of_Message_64 state 810 has three outputs, one of which was the loop back path just described. A second output causes flow back to the input of the Start_of_Message/Middle_of_Message state 804 when the logic condition of int_ic[2:0]=MOM * int_ic_hold[2:0]=SOM * parity_err=FALSE occurs. The remaining output causes flow back to the input of the Wait_for_SOM state 802 when the logic state of !(int_ic[2:0]=MOM+EOM_OK)+!(int_ic_hold[2:0]=SOM)+parity_err=TRUE occurs.

Although the preferred embodiment has been described in detail, it should be understood that various changes, substitutions and alterations can be made therein without departing from the spirit and scope of the invention as defined by the appended claims.

What is claimed is:

1. A communication interface for handling errors between network devices, comprising:
an output interface of a first network device for generating output control information and output parity information carried in output information transmitted therefrom; and
an input error-handling interface of a second network device, which input error-handling interface is in operative communication with the output interface to detect errors in the output information.

2. The interface of claim 1, wherein the parity information is determined based upon data information of the output information and the output control information.

3. The interface of claim 1, wherein the input error-handling interface detects errors in the output information by calculating input parity information of the output information, and comparing the input parity information with the output parity information to determine whether to terminate the output information.

4. The interface of claim 1, wherein the input error-handling interface detects errors in the output information by performing a parity check on the output information, and terminating the output information when a parity error is detected, which terminating occurs by performing at least one of discarding the output information, forwarding an error-free portion of the output information, and forwarding all of the erred output information.

5. The interface of claim 1, wherein the input error-handling interface recovers a boundary of the output information when an error in the output control information is not detected.

6. The interface of claim 1, wherein the input error-handling interface recovers a boundary of the output information by utilizing at least one tag bit to define the length of the output information when an error occurs in the output control information that is not detected.

7. The interface of claim 1, wherein the output control information defines a flow-control message that is routed substantially directly to an input port by bypassing a synchronization buffer of the input error-handling interface.

8. The interface of claim 1, wherein the input error-handling interface includes an internal interface logic operatively connected interstitial to the output interface and an internal input interface of the input error-handling interface such that the internal interface logic generates internal control information from the output control information and output parity information, and passes it to the internal input interface.

9. The interface of claim 8, wherein the internal control information includes at least one more bit than the output control information.

10. The interface of claim 1, wherein the input error-handling interface includes an internal interface logic operatively connected interstitial to the output interface and an internal input interface of the input error-handling interface such that the internal interface logic passes data of the output information unmodified to the internal input interface.

11. The interface of claim 1, wherein the first network device is one of a source distributed switch and a switching fabric device, and the second network device is one of a switching fabric device and a destination distributed switch.

12. The interface of claim 1, wherein the input error-handling interface synchronizes the output information to a system clock.

13. The interface of claim 1, wherein at least one input of each of the first network device and the second network device includes the input error-handling interface.

14. The interface of claim 1, wherein at least one output of each of the first network device and the second network device includes the output interface.

15. The interface of claim 1, wherein the input error-handling interface includes an internal interface logic that always sends at least one message to an internal interface for every internal clock period.

16. The interface of claim 15, wherein the at least one message includes an idle/flow control message when no other message is being transmitted.

17. The interface of claim 1, wherein the input error-handling interface detects an error in the middle of the output information and deletes a last word of the output information by marking a word previous to the last word.

18. The interface of claim 1, wherein the input error-handling interface processes the output information to generate a tag information when a message boundary is detected, which tag information is utilized by a queue of the second network device to recover a boundary of the processed output information when an expected length of the processed output information is different from an actual length of the processed output information.

19. A communication interface for processing errors between network devices, comprising:
an output interface of a first network device for generating output control information and parity information of output information transmitted therefrom; and
an error-handling interface of a second network device, which error-handling interface is in operative communication with the output interface to process the output control information and the parity information of the output information by,
checking parity of the parity information of the output information received from the first network device,
terminating the output information when an error in the parity is detected, and
recovering a boundary of the output information when an error in the output control information is detected.

20. The interface of claim 19, wherein the error-handling interface utilizes at least one tag bit to detect the boundary of the output information.

21. A method of handling errors between network devices, comprising:
providing an output interface of a first network device for generating output control information and output parity information carried in output information transmitted therefrom; and
providing an input error-handling interface of a second network device, which input error-handling interface is in operative communication with the output interface to detect errors in the output information.

22. The method of claim 21, wherein the parity information is determined based upon data information of the output information and the output control information.

23. The method of claim 21, wherein the input error-handling interface detects errors in the output information by calculating input parity information of the output information, and comparing the input parity information with the output parity information to determine whether to terminate the output information.

24. The method of claim 21, wherein the input error-handling interface detects errors in the output information by performing a parity check on the output information, and terminating the output information when a parity error is detected, which terminating occurs by performing at least one of discarding the output information, forwarding an error-free portion of the output information, and forwarding all of the erred output information.

25. The method of claim 21, wherein the input error-handling interface recovers a boundary of the output information when an error in the output control information is not detected.

26. The method of claim 21, wherein the input error-handling interface recovers a boundary of the output information by utilizing at least one tag bit to define the length of the output information when an error occurs in the output control information that is not detected.

27. The method of claim 21, wherein the output control information defines a flow-control message that is routed substantially directly to an input port by bypassing a synchronization buffer of the input error-handling interface.

28. The method of claim 21, wherein the input error-handling interface includes an internal interface logic operatively connected interstitial to the output interface and an internal input interface of the input error-handling interface such that the internal interface logic generates internal control information from the output control information and output parity information, and passes it to the internal input interface.

29. The method of claim 28, wherein the internal control information includes at least one more bit than the output control information.

30. The method of claim 21, wherein the input error-handling interface includes an internal interface logic operatively connected interstitial to the output interface and an internal input interface of the input error-handling interface such that the internal interface logic passes data of the output information unmodified to the internal input interface.

31. The method of claim 21, wherein the first network device is one of a source distributed switch and a switching fabric device, and the second network device is one of a switching fabric device and a destination distributed switch.

32. The method of claim 21, wherein the input error-handling interface synchronizes the output information to a system clock.

33. The method of claim 21, wherein at least one input of each of the first network device and the second network device includes the input error-handling interface.

34. The method of claim 21, wherein at least one output of each of the first network device and the second network device includes the output interface.

35. The method of claim 21, wherein the input error-handling interface includes an internal interface logic that always sends at least one message to an internal interface for every internal clock period.

36. The method of claim 35, wherein the at least one message includes an idle/flow control message when no other message is being transmitted.

37. The method of claim 21, wherein the input error-handling interface detects an error in the middle of the output information and deletes a last word of the output information by marking a word previous to the last word.

38. The method of claim 21, wherein the input error-handling interface processes the output information to generate tag information when a message boundary is detected, which tag information is utilized by a queue of the second network device to recover a boundary of the processed output information when an expected length of the processed output information is different from an actual length of the processed output information.

39. A method of handling errors in a network device, comprising the steps of:
receiving input information of an input port with an input error-handling interface of the network device;
processing the input information with the input error-handling interface to detect erred information and error-free information; and
transmitting with an output interface output information that includes the error-free information, output control information, and parity information.

40. The method of claim 39, wherein the input error-handling interface in the step of receiving detects errors in the input information by performing the steps of:
checking parity on the input information to detect the erred information; and
terminating the erred input information by performing one of discarding the erred information, forwarding an error-free portion of the erred information, and forwarding all of the erred information.

41. The method of claim 39, wherein the input error-handling interface recovers a boundary of the input information by utilizing at least one tag bit to define a length of the input information when an error in input control information of the input information is not detected.

42. The method of claim 39, wherein the input information includes input control information that defines a flow control message, which flow control message is routed substantially directly to a device input port by bypassing a synchronization buffer of the input error-handling interface.

43. The method of claim 39, wherein the network device is one of a distributed switch and a switching fabric.

44. The method of claim 39, wherein the input error-handling interface includes an internal interface logic that always sends at least one message to an internal interface for every internal clock period, which at least one message is an idle/flow control message when no other message is being transmitted.

45. The method of claim 39, wherein the input error-handling interface processes the input information to generate processed input information, which processed input information includes tag information associated with a message boundary, and which tag information is utilized by a queue of the network device to recover a boundary of the processed input information when an expected length of the processed input information is different from an actual length of the processed input information.

46. The method of claim 39, wherein the input error-handling interface includes an internal interface logic operatively connected interstitial to the input port and an internal input interface of the input error-handling interface, such that the internal interface logic generates internal control information from the input information and passes the internal control information to the internal input interface.

47. The method of claim 39, wherein the input error-handling interface detects an error in the middle of the erred information and deletes a last word of the erred information by marking a word previous to the last word.

48. The method of claim 39, wherein the input error-handling interface detects the erred information by calculating input parity information of the input information, and comparing the input parity information with transmitted parity information of the input information.

49. A method of handling errors in a network device, comprising the steps of:
receiving input information of an input port with an input error-handling interface of the network device;
checking parity on the input information with the input error-handling interface to detect erred information and error-free information;
terminating the erred information by performing one of discarding the erred information, forwarding an error-free portion of the erred information, and forwarding all of the erred information;
transmitting with an output interface output information that includes the error-free information, output control information, and parity information.

50. The method of claim 49, wherein the input error-handling interface recovers a boundary of the input information by utilizing at least one tag bit to define a length of the input information when an error in input control information of the input information is not detected.
